(19) United States
(12) Patent Application Publication
(10) Pub. No.: US 2014/0352218 A1
(43) Pub. Date: Dec. 4, 2014

(54) Joints for Shutter Frames and Methods for Forming Same

(71) Applicant: Houston Shutters, LLC, Houston, TX (US)

(72) Inventors: Michael Blackburn, Houston, TX (US); Jennifer Baur, Houston, TX (US)

(21) Appl. No.: 13/907,295

(22) Filed: May 31, 2013

(51) Int. Cl. E06B 7/086; E06B 7/10

(52) U.S. Cl. CPC E06B 7/086; E06B 7/10
USPC 49/92.1; 49/506

(57) ABSTRACT

A louvered shutter panel, such as for windows and doors, includes a pair of spaced-apart stiles, each stile having a longitudinally extending groove. The groove in each stile includes a first portion having a first cross-sectional shape and an adjacent second portion having a second cross-sectional shape. A pair of spaced-apart rails extends between the stiles, each of the rails having a tabbed portion received within the groove of the stile. The shutter panel also includes elongate inserts received within a portion of the groove of the stile. A plurality of louvers include pins that are rotationally received within spaced-apart holes in the inserts.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Field of the Disclosure

This disclosure relates generally to frames for holding objects or for aesthetically accenting objects. More particularly, it relates to frames for holding shutters, and to assemblies of frames and shutters applicable for installation with windows and doors.

2. Background Information

The design, fabrication, assembly, and installation of shutters for window and door openings or casings can add storm protection, privacy, or aesthetic beauty to homes and other buildings. Some shutter assemblies are functional, such as panels that pivotally mount to a window or door casing, allowing the panels to be selectively pivoted to cover the window or door opening or pivoted to the side of the opening. Other shutters are cosmetic, giving aesthetic appeal without allowing movement. Panels for functional or cosmetic shutters commonly include a series of louvers, e.g. over-lapping boards. For functional shutters, the louvers may be pivotable or rigid relative to a panel frame.

Design features that reduce manufacturing, assembly, and/or transportation costs and/or that simplify the assembly of shutters are desirable to maintain an economic advantage.

### BRIEF SUMMARY OF THE DISCLOSURE

These and other needs in the art are addressed in one embodiment by a shutter panel. In an embodiment, the shutter panel comprises a pair of spaced-apart stiles, each stile having a longitudinally extending groove, the groove comprising a first portion having a first cross-sectional shape and a second portion adjacent to the first portion and having a second cross-sectional shape. In addition, the shutter panel comprises a pair of spaced-apart rails extending between the stiles, each of the rails having a tabbed portion received within the first portion of the groove of the stile. An elongate insert is received within the second portion of the groove of the first stile and extends in a direction generally parallel to the groove, the insert comprising a plurality of spaced-apart holes. The shutter panel includes a plurality of louvers having pins extending therefrom, the pins being received within holes of the insert and adapted for rotation within the holes.

In another embodiment, a shutter assembly comprises a frame and at least one louvered shutter panel pivotably attached to the frame. The louvered shutter panel comprises a pair of spaced-apart stiles, each stile having a longitudinally extending groove, the groove comprising a first portion having a generally trapezoidal-shaped cross section and a second portion adjacent to the first portion and having a generally rectangular-shaped cross section. The louvered shutter panel includes a pair of spaced-apart rails extending between the stiles, each of the rails having ends comprising a base portion and a tabbed portion extending therefrom; wherein each tabbed portion has a generally trapezoidal-shaped cross section that is received within the first portion of a groove of one of the stiles. Further, the louvered shutter panel comprises a pair of opposing elongate inserts, each insert having a plurality of spaced-apart holes and being disposed within the second portion of the groove of one of the stiles and extending in a direction generally parallel to the longitudinally extending groove. A plurality of louvers include extending pins that are received within the holes and adapted for rotation within the holes.

A method for fabricating a shutter assembly is disclosed and includes forming a pair of grooved stiles, each stile having a longitudinally extending, multi-sectioned groove, the multi-sectioned groove comprising a first portion and a second portion adjacent to the first portion; wherein the cross-sectional shape of the second portion differs from the cross-sectional shape of the first portion. The method comprises forming a pair of rails, each of the rails having a pair of ends, each end comprising a cross-sectional shape complementary of first and second portions of the multi-sectioned groove. The ends of the first rail are disposed into the multi-sectioned grooves of the stiles to form a first and a second joint; and the ends of the second rail are disposed into the multi-sectioned grooves of the stiles to form a third and a fourth joint, thereby assembling a first shutter panel.

The various embodiments described herein comprise a combination of features and characteristics intended to address various shortcomings associated with certain prior devices, systems, and methods. The various features and characteristics described above, as well as others, will be readily apparent to those of ordinary skill in the art upon reading the following detailed description, and by referring to the accompanying drawings.

### BRIEF DESCRIPTION OF THE DRAWINGS

For a detailed description of the disclosed embodiments of the disclosure, reference will now be made to the accompanying drawings in which:

FIG. 1 is a perspective front view of a shutter assembly in accordance with principles described herein;

FIG. 2 is a front elevation view of a shutter panel of the shutter assembly of FIG. 1 in accordance with principles described herein;

FIG. 3 is a plan view of a louver of the shutter panel of FIG. 2 in accordance with principles described herein;

FIG. 4 is an enlarged end view of a stile of the shutter panel of FIG. 2 in accordance with principles described herein;

FIG. 5 is an end view of the shutter panel of FIG. 2 in accordance with principles described herein;

FIG. 6 is a perspective view in partial cross-section of a lower corner portion of the shutter panel of FIG. 2 in accordance with principles described herein;

FIG. 7 is a perspective view of an upper corner portion of shutter panel of FIG. 2 in accordance with principles described herein;

FIG. 8 presents a flow diagram showing a method for fabricating a shutter assembly in accordance with principles disclosed herein;

FIG. 9 is an elevation view of two C-shaped partial-frames configured to form the frame for the shutter assembly of FIG. 1 in accordance with principles described herein; and

FIG. 10 is an enlarged perspective view of a camming fastener having two members compatible with the two C-shaped partial-frames of FIG. 9 in accordance with principles described herein.

FIGS. 11A to 11D are enlarged end views of various stile embodiments compatible with the shutter panel of FIG. 2 in accordance with principles described herein;

### NOTATION AND NOMENCLATURE

The following description is exemplary of certain embodiments of the disclosure. One of ordinary skill in the art will understand that the following description has broad application, and the discussion of any embodiment is meant only to be exemplary of that embodiment, and is not intended to suggest in any way that the scope of the disclosure, including the claims, is limited to that embodiment.

The drawing figures are not necessarily to scale. Certain features and components disclosed herein may be shown exaggerated in scale or in somewhat schematic form, and some details of conventional elements may not be shown in the interest of clarity and conciseness. In some of the figures, in order to improve clarity and conciseness of the figure, one or more components or aspects of a component may be omitted or may not have reference numerals identifying the features or components that are identified elsewhere. In addition, among the drawings, like or identical reference numerals may be used to identify common or similar elements.

The terms “including” and “comprising” are used herein including the claims, in an open-ended fashion, and thus should be interpreted to mean “including, but not limited to . . . .” Also, the term “couple” or “couples” is intended to mean either an indirect or direct connection. Thus, if a first component couples or is coupled to a second component, the connection between the components may be through a direct engagement of the two components, or through an indirect connection that is accomplished via other intermediate components, devices and/or connections. The recitation “based on” means “based at least in part on.” Therefore, if X is based on Y, X may be based on Y and any number of other factors.

In addition, as used herein including the claims, the terms “axial” and “axially” generally mean along or parallel to a given axis (e.g., central axis of a body or a port), while the terms “radial” and “radially” generally mean perpendicular to the axis. For instance, an axial distance refers to a distance measured along or parallel to a given axis, and a radial distance means a distance measured perpendicular to the axis. Any reference to a relative direction with respect to an object, for example “top,” “bottom,” “up”, “upward,” “left,” “leftward,” “down”, and “lower” is made for purpose of clarification and pertains to the orientation as shown in the particular Figure being described. If the object were viewed from another orientation or implemented in another orientation, it may be appropriate to described direction using an alternate term.

### DETAILED DESCRIPTION OF THE DISCLOSED EMBODIMENTS

This disclosure presents a shutter panel and also a shutter assembly both applicable to window and door openings, frames, or casings. In various embodiments, the shutter assembly includes at least one such panel coupled to a frame, and the panel includes multiple louvers. In various embodiments, the shutter panel includes a pair of stiles, a pair of rails extending between the stiles, a pair of stile inserts mounted in grooves formed within the stiles, and multiple louvers rotationally coupled to the stile inserts. The stiles include multi-sectioned grooves to receive the rail ends and to join the stiles to the rails and to the stile inserts. In at least some embodiments, the shutter assembly is functional, having a shutter panel pivotally mounted to the frame assembly, allowing the panel to be selectively positioned within the window or door opening or to the side of the opening.

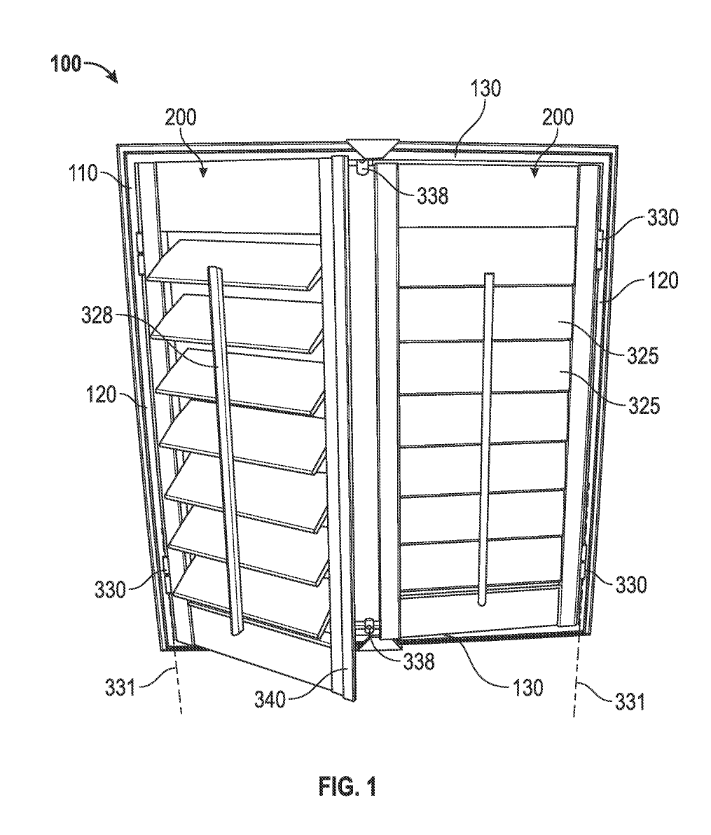

Referring to FIG. 1, an exemplary embodiment of a shutter assembly is shown in perspective view. Shutter assembly 100 includes a frame 110 and multiple shutter panels pivotally coupled to frame 110. In this embodiment, the shutter panels are two louvered panels 200. Frame 110 includes a pair of elongate side members 120 and a pair of elongate, generally parallel cross-members 130 spaced-apart from one another and extending between the side members 120. In the orientation shown, side members 120 are vertical, and cross-members 130 are horizontal.

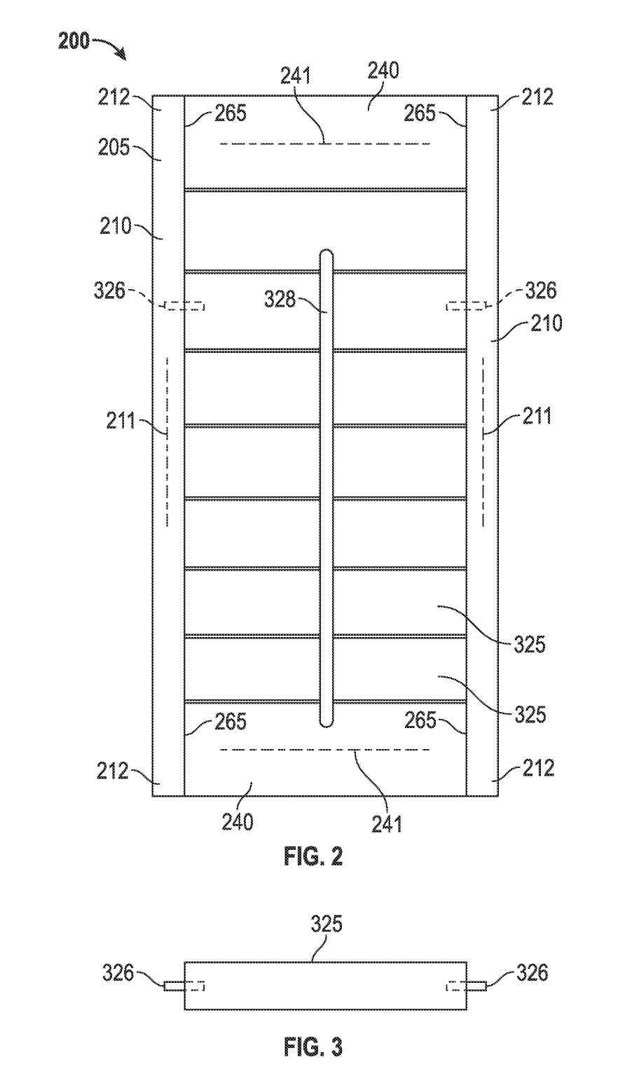

Referring to FIG. 2, louvered panel 200 includes a panel frame 205, multiple louvers 325, and a lifting bar 328. Panel frame 205 includes a pair of parallel, spaced-apart stiles 210 and a pair of parallel rails 240 spaced-apart and extending between stiles 210. A shown in FIG. 3, louvers 325 are elongate and have two cylindrical axis pins or pin members 326 mutually aligned and extending from opposing ends of louver 325. In this example, each pin 326 is received within a hole formed within louver 325. In the assembled louvered panel 200 of FIG. 2, the two pins 326 rotationally couple the louver 325 between the two stiles 210, parallel to rails 240.

Returning to FIG. 1, two hinges 330 pivotally couple the louvered panel 200 to one of the side members 120 of frame 110. The pair of hinges 330 has a common axis of rotation 331 parallel to the side member 120. An elongate member 340, which is also called an astragal, is coupled to the front surface of one of the louvered panels 200 and extends lengthwise along the edge of one of the stiles 210. The astragal 340 extends from the louvered panel 200 in a transverse direction to cover a portion of the other louvered panel 200 in various instances. A magnetic latch (not shown) is coupled to the backside of the same panel 200 that has the astragal 340. Two ferrous stop-brackets 338 are attached to frame 110, one stop-bracket 338 on each of the cross-members 130. The combination of astragal 340, the magnetic latches, and the two stop-brackets 338 configure the two louvered panels 200 to be releasably retained within frame 110 of shutter assembly 100, parallel to cross-members 130, i.e. to be selectively held closed with respect to frame 110. Rotation of a louvered panel 200 about its axis of rotation 331 opens the panel with respect to frame assembly 110.

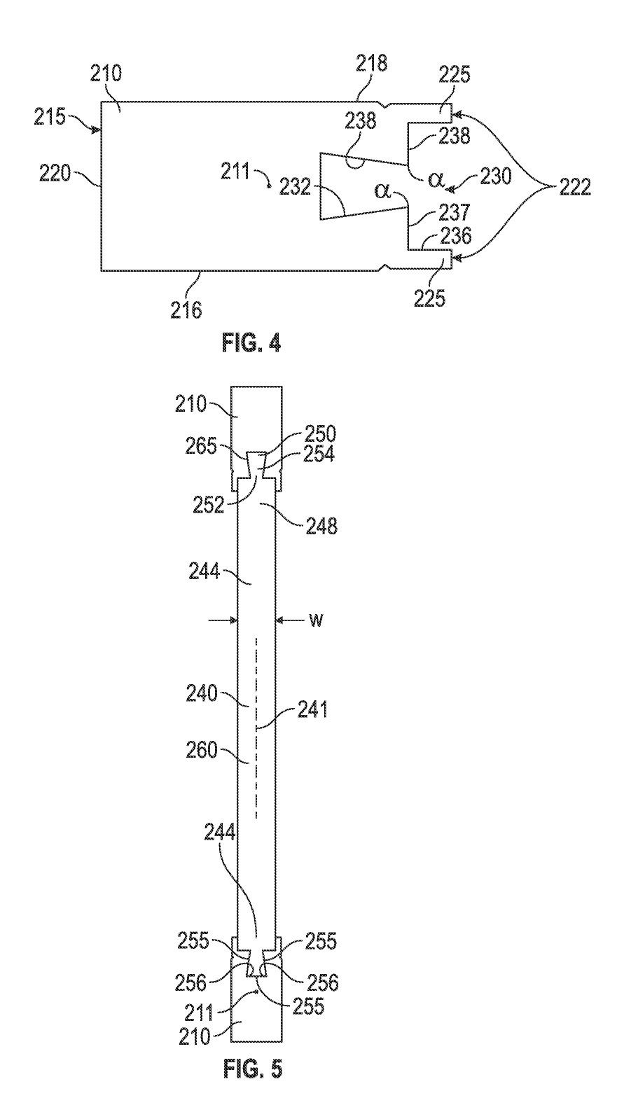

As shown in FIG. 2, each stile 210 includes a longitudinal axis 211 and two spaced-apart ends 212. Better shown in the end view of FIG. 4, stile 210 also includes an outer surface 215 and a longitudinal multi-sectioned groove 230 that extends the full length of stile 210. Stile 210 will also be called grooved stile 210. Outer surface 215 has four faces in this embodiment, including a front face 216, a rear face 218, an outside face 220 between the faces 216, 218, and an inside face 222 distal the outside face 220. Multi-sectioned groove 230 intersects the inside face 222, leaving two shoulders 225, one on each side of groove 230. The first shoulder 225 adjoins front face 216, and the second shoulder 225 adjoins rear face 218. Thus, groove 230 is disposed between the front and rear faces 216, 218 and, at least in this embodiment, groove 230 does not intersect front face 216 and does not intersect rear face 218.

As shown in end view of stile 210 in FIG. 4, multi-sectioned groove 230 includes multiple, distinguishable geometric sections or portions. In this embodiment, multi-sectioned groove 230 includes a first or inner portion 232, a second or outer portion 236 adjacent inner portion 232, and a boundary 237. The cross-sectional shape of grove 230 will be described in reference to the portions 232, 236. As used herein, including the claims, the cross-sectional shape of groove 230 is defined as being in a plane that is generally perpendicular to the longitudinal extent of the groove, i.e. perpendicular to stile axis 211. In this embodiment, inner portion 232 has a generally trapezoidal-shaped cross section, and outer portion 236 has a generally rectangular-shaped cross section. The outer portion 236 is proximal the outer surface 215, and, in particular, outer portion 236 intersects the inside face 222. The inner portion 232 is distal the outer surface 215. The boundary 237 of groove 230 is formed by surface regions of the inner portion 232 and the outer portion 236. Boundary 237 includes a plurality of planar surface regions 238. The planar surface regions 238 are represented as line segments in end view of FIG. 4. Two intersecting planar surface regions 238 form a corner α (alpha) having an angle of greater than 180 degrees, as measured within groove 230. The embodiment of FIG. 4, has two such corners α, while some embodiments have more or fewer than two corners α, based on the shapes of inner portion 232 and outer portion 236.

Referring now to FIG. 5, rail 240 includes a longitudinal axis 241, an outer surface 242, two spaced-apart ends 244, and a central portion 260 extending between ends 244. Each end 244 has a base portion 248 and a tabbed portion 250 that extends from base portion 248 in the direction of axis 241. Tabbed portion 250 includes a root feature 252 and a body feature 254 extending from root 252. Root 252 couples body feature 254 to base portion 248. In this embodiment, body feature 254 includes a width greater than a width of the root 252, and body feature 254 has a variable width that grows as the body feature extends away from root 252. As shown in this embodiment, tabbed portion 250 has three planar sides 255 that intersect in two acute angles 256 when viewed in cross section. In various embodiments, the apexes of these acute angles are filleted or chamfered to reduce the potential for breakage during shipping or assembly.

To facilitate the assembly of rail 240 with stile 210, tabbed portion 250 has a cross-sectional shape corresponding to the shape of the inner portion 232 of groove 230. Base portion 248 has a cross-sectional shape corresponding to the shape of the outer portion 236 of groove 230. Base portion 248 and is characterized by a width “W.” In an assembled panel 200, tabbed portion 250 is received within inner portion 232, and base portion 248 is received within outer portion 236. In the embodiment of FIG. 5, as viewed from the top, tabbed portion 250 has a generally trapezoidal-shaped cross-section, and base portion 248 has a generally rectangular-shaped cross section. Ends 244 of rails 240 are adapted to be slidingly received and transversely restrained within the grooves 230 of the pair of opposing stiles 210. Central portion 260 of rail 240 is characterized by the same width W, as are base portions 248 of the ends 244. In various other embodiments, central portion 260 has a width that is less than the width W or that is greater than width W. For example in some instances, central portion 260 has a width equal to the width or thickness of stile 210 so that some portions of the outer surfaces 215, 242 are flush.

Referring still to FIG. 5, the coupling of the tabbed portion 250 with the groove inner portion 232 forms an interlocked joint 265, preventing rail 240 from moving relative to stile 210 along rail axis 241. Furthermore, interlocked joints 265, when applied to a pair of stiles 210 and a pair of rails 240, retains inserts 270 and louvers 325 within louvered panel 200. For this reason, tabbed portions 250 and the groove inner portions 232 may be described as locking features, adapted to form interlocked joints 265 for panel 200 when assembled. Multi-sectioned groove 230 may also be described as a locking groove due to the locking feature, i.e. inner portion 232. A frictional fit, an adhesive, and/or a fastener (not shown) at joint 265 restricts or prevents the movement of rail 240 along stile axis 211. Rail axis 241 is perpendicular to stile axis 211.

Tabbed portion 250, having a trapezoidal shape in this embodiment, is also called a dovetail. The trapezoidal inner portion 232 of groove 230 is also called a dovetail channel. Interlocked joint 265 is also called a dovetail joint.

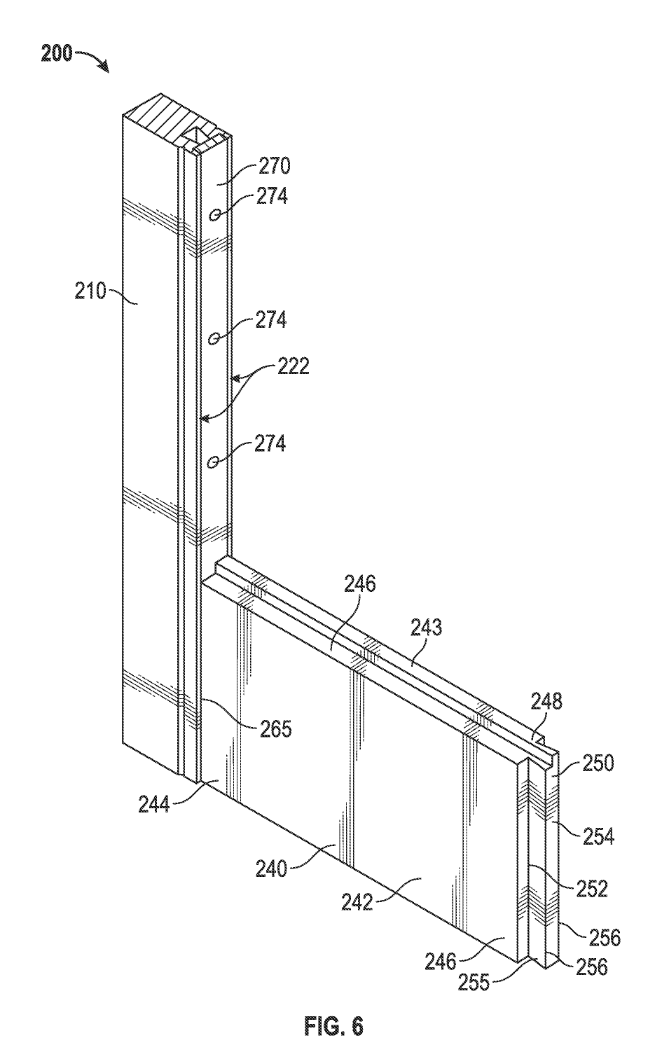

FIG. 6 shows one rail 240 coupled to one stile 210. An elongate insert 270 having a cross-sectional corresponding to the shape outer portion 236 of groove 230 is received within outer portion 236. Thus, in this embodiment, insert 270 has a generally rectangular-shaped cross section. Insert 270 will also be called a stile insert. As a whole, louvered panel 200 includes a pair of inserts 270 with each insert 270 received within the outer portion 236 of the groove 230 of one of the pair of space-apart, opposing stiles 210. The inserts 270 extend in a direction generally parallel to the multi-sectioned groove 230, i.e. generally parallel to stile axis 211. In the embodiment of FIG. 2 and FIG. 6, the combined length that includes the vertical height of two rails and the length of one insert 270 is equal to the length of one stile 210, and so the inserts 270 extend fully between the rails 240. As best shown in FIG. 6, insert 270 includes a series of spaced-apart holes 274 that face the inner region of panel frame 205. In an assembled louver panel 200, cylindrical axis pins 326 of the multiple louvers 325 are rotationally received within the holes 274 of opposing inserts 270.

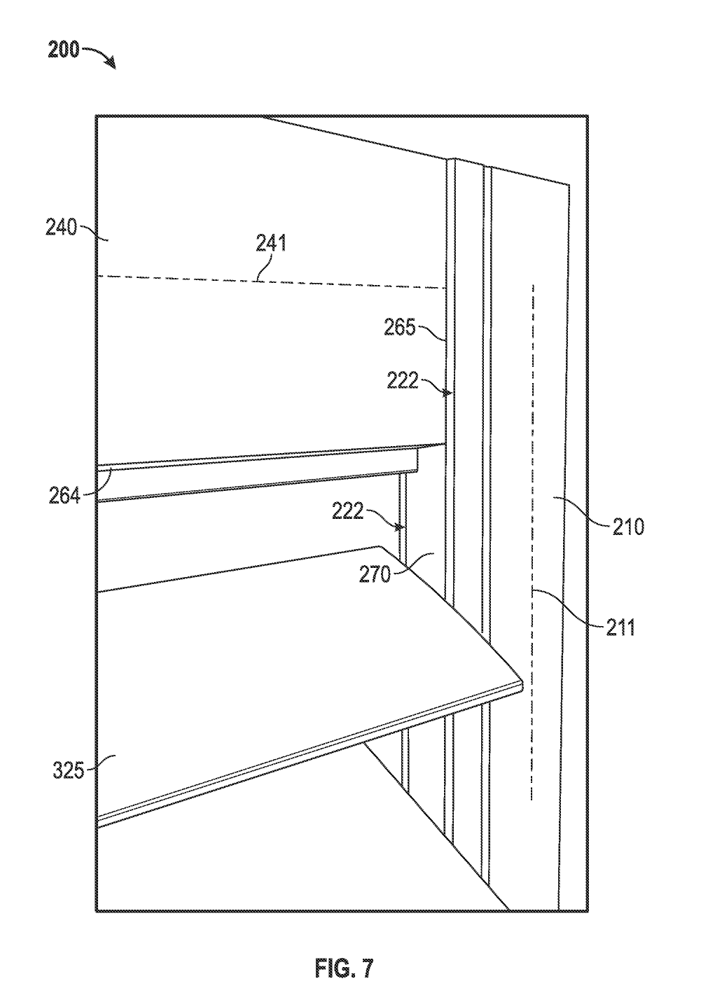

FIG. 7 is an enlarged perspective view of a corner portion of louvered panel 200 showing the assemblage of stile 210, rail 240, insert 270, and multiple louvers 325. As shown in FIG. 6 and FIG. 7, outer surface 242 of rail 240 includes an inside face 243 and a longitudinal corner recess 264 adjoining inside face 243. Recess 264 extends between the two ends 244. Recess 264 is configured to receive an elongate edge of one of the plurality of louvers 325.

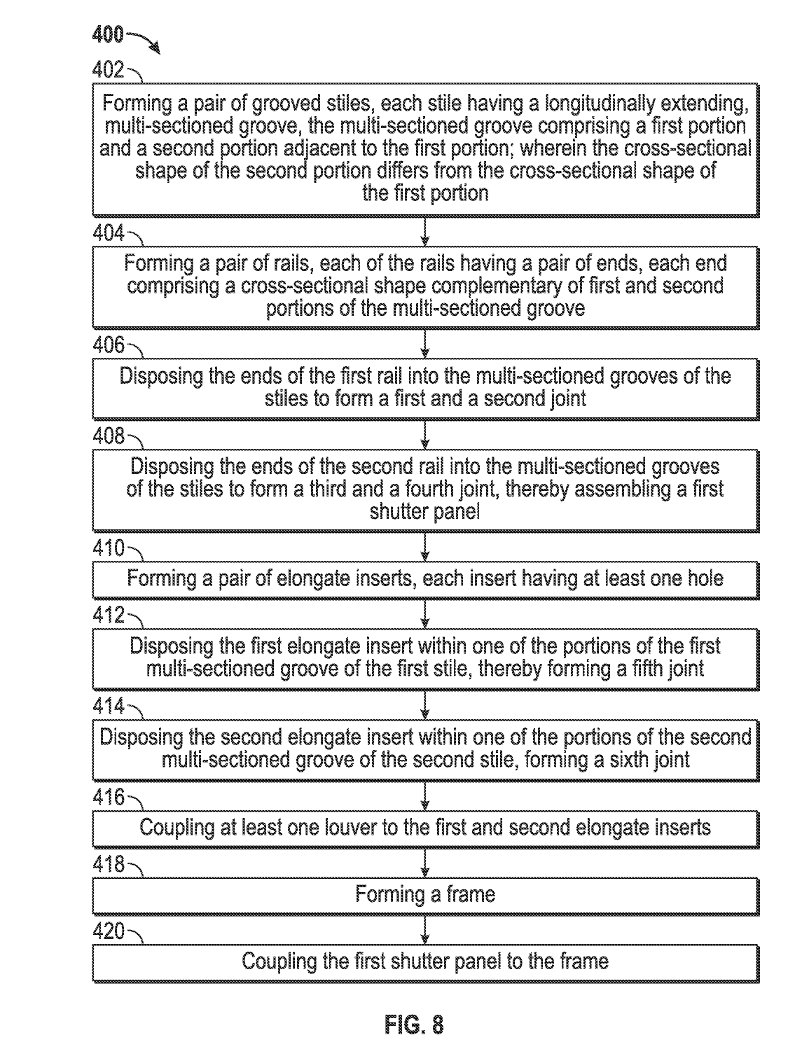

FIG. 8A and FIG. 8B show a method 400 for fabricating a shutter assembly in accordance with principles described herein. At block 402, method 400 includes forming a pair of grooved stiles, each stile having a longitudinally extending, multi-sectioned groove, the multi-sectioned groove comprising a first portion and a second portion adjacent to the first portion; wherein the cross-sectional shape of the second portion differs from the cross-sectional shape of the first portion. Block 404 includes forming a pair of rails, each of the rails having a pair of ends, each end comprising a cross-sectional shape complementary of first and second portions of the multi-sectioned groove. Block 406 includes disposing the ends of the first rail into the multi-sectioned grooves of the stiles to form a first and a second joint. Block 408 includes disposing the ends of the second rail into the multi-sectioned grooves of the stiles to form a third and a fourth joint, thereby assembling a first shutter panel. Block 410 includes forming a pair of elongate inserts, i.e. stile inserts, each insert having at least one hole. Block 412 includes disposing the first elongate insert within one of the portions of the first multi-sectioned groove of the first stile, thereby forming a fifth joint. Block 414 of method 400 includes disposing the second elongate insert within one of the portions of the second multi-sectioned groove of the second stile, forming a sixth joint. Block 416 includes coupling at least one louver to the first and second elongate inserts. Block 418 includes forming a frame. Block 420 includes coupling the first shutter panel to the frame.

Various implementations of method 400 include additional steps based on any of the concepts presented in this written description, including the figures. Various other implementations of method 400 may include fewer steps than described. Using louvered panel 200 as an example, in various instances, disposing one of the ends 244 of a rail 240 into the multi-sectioned groove 230 of the stile 210 includes sliding the base portion 248 of the rail 240 into the longitudinally extending, multi-sectioned groove 230 of the stile 210, which includes moving the rail 240 in the direction of stile axis 211.

In some instances, a manufacturing, shipping, or installation advantage is gained by choosing specific sequences for various steps of fabricating a shutter assembly. For example, in some instances, before the ends 244 of the first rail 240 are positioned within the stiles 210, the first elongate insert 270 is positioned within the first stile 210, and also the second elongate insert 270 is positioned within the second stile 210. Furthermore, in some instances, the first and second pins 326 of the louver 325 are inserted into holes 274 in the first and second elongate inserts 270 before the ends 244 of the first rail 240 are disposed into the stiles 210 and before the ends 244 of the second rail 240 are disposed into the stiles 210. Multiple louvers 325 may be selectively installed in the same manner.

As another example, in various other instances, the ends 244 of the first rail 240 are coupled to the stiles 210 before the first elongate insert 270 is positioned within the first stile 210. In some instances, the two pins 326 of the louver 325 are inserted into holes 274 in the two elongate inserts 270, forming a loose assembly, before the inserts 270 are simultaneously slid into the outer portions 236 of the stile grooves 230, sliding parallel to axis 211. Multiple louvers 325 may be selectively installed in the same manner. Afterwards, the second rail 240 is coupled to the stiles 210 opposite the first rail 240.

In various derivations of method 400, any of a variety of shutter panels may be utilized, including generally flat, stylized, or louvered panels, for example.

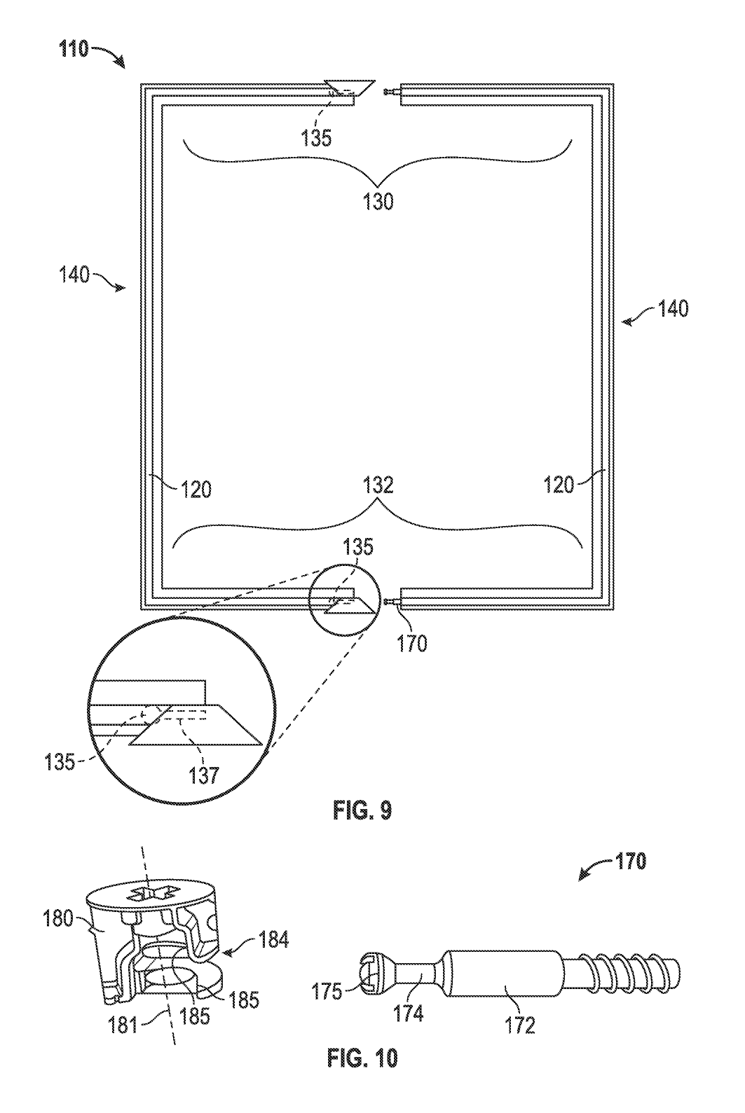

In some instances, pre-forming frame 110 as two connectable and separable C-shaped partial-frames 140, as shown in FIG. 9, is advantageous for manufacturing, shipping, or installation purposes. In FIG. 9, the two partial-frames 140 are connectable and separable along the length of each of the two cross-members 130. To facilitate this connection and separation capability, each cross-member 130 is divided into a left part and a right part, and a fastener 170 is employed at each cross-member 130 to splice the two partial-frames 140 into the complete four-sided frame 110 of FIG. 1. As shown in FIG. 10, an example of a compatible fastener 170 includes two inter-meshing members. The first, a pin member 172, includes a head 175 extending from a partially threaded shaft. The second, a grasping or receiving member 180, includes an axis of rotation 181, a recess 184 extending perpendicular to rotation axis 181, and two cam surfaces 185 adjacent recess 184 configured to engage pin head 175. Thus, in this example, fastener 170 is a two-member or two-part, camming fastener.

As oriented in FIG. 9, pin member 172 extends from the right part of cross-member 130. Receiving member 180 is rotatably received inside a cross-wise bore 135 within the left part of cross-member 130 such that axis of rotation 181 is perpendicular to cross-member 130. During assembly, pin member 172 extends into an axial bore 137 in the left part of cross-member 130 and into receiving member recess 184. For this purpose, axial bore 137 intersects cross-wise bore 135. Receiving member 180 is then rotated about its axis of rotation 181, cam surfaces 185 engage pin head 175, applying an axially-directed force to pin member 172 and to the two parts of cross-member 130. Receiving member 180 is adapted to draw together the C-shaped partial-frames 140 in this manner.

Referring again to FIG. 1, in some instances, a manufacturing, shipping, or installation advantage may be achieved when a shutter panel, such as a louvered panel 200, is coupled to a C-shaped partial-frame 140 (FIG. 9) to form a shutter sub-assembly 370 prior to forming a four-sided frame 110. In some of these instances, at least one pair of complementary shutter sub-assemblies 370 will be formed in one location, and shutter assembly 100 will be formed from the pair of shutter sub-assemblies 370 at another location, such as at the location where the shutter assembly will be installed.

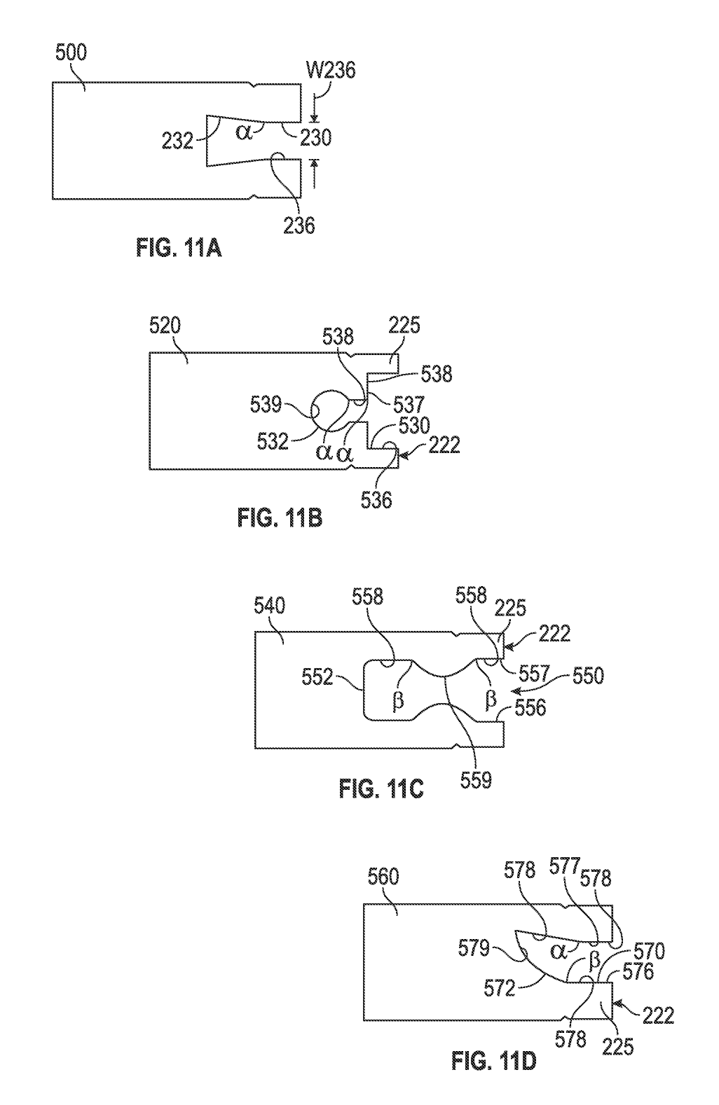

FIGS. 11A to 11D present end views of various stile embodiments applicable in a shutter panel, including embodiments of louvered panel 200. The stiles of FIGS. 11A to 11D include longitudinally extending grooves of various cross-sectional shapes, each groove having multiple sections or portions. For example, FIG. 11A shows a variation of stile 210, which will be called stile 500 for clarity. In stile 500, the outer portion 236 of groove 230 has a width W that is less than or equal to the width of all aspects of inner portion 232.

Referring now to FIG. 11B for another example, a stile or grooved stile 520 includes a longitudinally extending, multi-sectioned groove 530 having a first or inner portion 532, a second or outer portion 536, and a boundary 537, which shares multiple planar surface regions 538 and a curved surface region 539 together with portions 532, 536. In this embodiment, curved surface region 539 is concave. Stile 520 also includes an inside face 222 and two shoulders 225 similar to the identically number features of stile 210 in FIG. 4. Inner portion 532 includes curved surface region 539, which has an arc greater than ninety degrees, and two parallel surface regions 538 adjacent region 539, giving inner portion 532 a key-hole shape. More specifically, in the embodiment of FIG. 11B, curved surface region 539 has an arc greater than 180 degrees. Two of the planar surface regions 538 of boundary 537 form a corner a (alpha) having an angle of greater than 180 degrees, as measured within groove 530 or facing groove 230. Curved surface region 539 on boundary 537 forms another corner α with an adjacent planar surface region 538. Again, corner α (alpha) has an angle of greater than 180 degrees. In this embodiment, boundary 537 of groove 530 has four corners α, formed as described. Various embodiments, include at least one curved surface region 539, and have at least one corner α greater than 180 degrees. In another variation, stile 520 includes inner portion 532 that is divided into two portions, one being generally round in cross section and the other being generally rectangular. Then, combined with the generally rectangular outer portion 536, groove 530 is regarded to have three geometric sections or portions rather than two.

Grooved stile 540 of FIG. 11C includes a longitudinally extending, multi-sectioned groove 550 having a first or inner portion 552, a second or outer portion 556, and a boundary 557 sharing multiple planar surface regions 558 and two curved surface regions 559 together with portions 552, 556. In this embodiment, curved surface regions 559 are convex and are positioned to be symmetrically opposed to each other. Stile 540 also includes an inside face 222 and two shoulders 225. Each curved surface region 559 intersects two of the planar surface regions 558, forming two corners β (beta). Corners β have angles of less than 180 degrees, as measured from the within or facing groove 550. In this embodiment, the two curved surface regions 559 form four such corners β with adjacent surface regions 558. Various embodiments, include at least one curved surface region 559, and have at least one corner β that is less than 180 degrees.

Grooved stile 560 of FIG. 11D includes a longitudinally extending, multi-sectioned groove 570 having a first or inner portion 572, a second or outer portion 576, and a boundary 577 sharing multiple planar surface regions 578 and a curved surface region 579 together with portions 572, 576. In this embodiment, curved surface region 579 is concave. Stile 560 also includes an inside face 222 and two shoulders 225. Curved surface region 579 has an arc less than 90 degrees. Two of the planar surface regions 578 of boundary 577 form a corner α having an angle of greater than 180 degrees, as measured within groove 570 or facing groove 270. Curved surface region 579 intersects one of the planar surface regions 578, forming a corner β having an angle of less than 180 degrees, as measured from the within or facing groove 550. Groove 570 is non-symmetrical. In some embodiments of grooved stile 560, curved surface region 579 has an arc of 90 degrees or more.

In various embodiments, the corner α or the corner β of a multi-sectioned groove in a stile includes a fillet or a chamfer. In some embodiments, a multi-sectioned groove is centered on inside face 222 of a stile, while in other embodiments, a multi-sectioned groove is not centered on inside face 222. In various embodiments of stiles made in accordance with the teachings herein, a corner α or β may be formed at the intersection any combination of two surface regions, planar or curved. In general, a curved surface region of a multi-sectioned groove may be concave, convex, or may have concave and convex portions. Various stile embodiments shown in FIGS. 4 and 11A-11D include additional angles α or β that have not been annotated.

Various embodiments of louvered panel 200 or another a shutter panel are formed using a pair of any of the stiles 500, 520, 540, 560 together with a pair of rails having ends adapted to be slidingly received and transversely restrained within the corresponding longitudinally extending groove 230, 530, 550, 570. The ends of these rails include a base portion 248 and a tabbed portion 250 having shapes that may differ from the identically numbered features shown in FIG. 5. For example, when using stile 520 of FIG. 11B, the end of the corresponding rail has a tabbed portion 250 that includes a generally rectangular root feature 252 and a round body 254 feature. In some instances, a single shutter panel includes two different stiles having different longitudinally extending, multi-sectioned grooves, for example to insure a certain arrangement of the components.

Various embodiments consistent with the present disclosure have been presented. Multiple additional variations are possible in accordance with principles described herein. Examples are given here:

Various embodiments of stiles include a longitudinally extending multi-sectioned groove having an outer portion 236 with a shape other than rectangular, such as a trapezoidal cross section, and the method for assembling the shutter panel is adjusted to compensate. Correspondingly, the insert member for the stile has a cross-section, as viewed from an end, that is a shape other than rectangular. Also, as exemplified by stile 520 in FIG. 11B, a longitudinally extending multi-sectioned groove may have more than two sections or portions. Although FIGS. 12A to 12D show curve surface regions having planar surface regions located on both sides of the curved surface region, some embodiments include a groove boundary having two or more adjacent curved surface regions.

Although, inserts 270 extend fully between the rails 240 in FIG. 2 and FIG. 6, in other embodiments, stile inserts 270 may be shorter and may be restrained against moving parallel to stile axis 211 by friction, adhesive, or a fastener.

Various embodiments of a louvered panel include a louver 325 fixed to the panel frame 205 without pin members 326 coupled to the ends of the louver. As compared to the one corner recess 264 in FIG. 6, the outer surface 242 of rail 240 in some other embodiments includes two longitudinal corner recesses 264 adjoining inside face 243 and configured to receive an elongate edge of one of the plurality of louvers 325, while still other embodiments include no corner recesses 264.

While exemplary embodiments have been shown and described, modifications thereof can be made by one of ordinary skill in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. The inclusion of any particular method step or action within the written description or a figure does not necessarily indicate that the particular step or action is necessary to the method. Unless expressly stated otherwise, the steps listed in a description of a method or in a method claim may be performed in any order, and in some instances two or more of the method steps may be performed in parallel, rather than serially.

What is claimed is:

1. A shutter panel comprising:
a pair of spaced-apart stiles, each stile having a longitudinally extending groove, the groove comprising a first portion having a first cross-sectional shape and a second portion adjacent to the first portion and having a second cross-sectional shape;
a pair of spaced-apart rails extending between the stiles, the rails having a tabbed portion at each end that is received within the first portion of a groove of a stile;
an elongate insert received within the second portion of at least one of the grooves and extending in a direction generally parallel to the groove, the insert comprising a plurality of spaced-apart holes; and
a plurality of louvers having pins extending therefrom, at least some of the pins being received within holes of the insert and adapted for rotation within the holes.

2. The shutter panel of claim 1 wherein the tabbed portion of the rails extends from a rail portion having a width W, and wherein the rail portion of width W is received within the second portion of the groove of the stile.

3. The shutter panel of claim 2 wherein the tabbed portion comprises a root feature and a body feature extending therefrom;
wherein the body feature includes a width greater than a width of the root feature.

4. The shutter panel of claim 1 wherein the cross-sectional shape of the first portion of the groove is generally trapezoidal, and the cross-sectional shape of the second portion of the groove is generally rectangular.

5. The shutter panel of claim 1 wherein the tabbed portion of the rails comprises a plurality of generally planar sides that, when viewed in cross section, intersect in at least two acute angles.

6. The shutter panel of claim 5 wherein the tabbed portion of the rails extends from a rail portion having a width W; and
wherein the rail portion of width W is received within the second portion of the groove of the stile.

7. The shutter panel of claim 6 wherein the cross-sectional shape of the first portion of the groove is generally trapezoidal, and the cross-sectional shape of the second portion of the groove is generally rectangular.

8. The shutter panel of claim 1 wherein the groove further comprises a boundary having a first surface region and a second surface region that form a corner having an angle of greater than 180 degrees as measured within the groove.

9. The shutter panel of claim 1 wherein the groove further comprises a corner formed by a first surface region and a convex surface region.

10. A shutter assembly comprising:
a frame;
at least one louvered shutter panel pivotably attached to the frame;
wherein the louvered shutter panel comprises;
a pair of spaced-apart stiles, each stile having a longitudinally extending groove, the groove comprising a first portion having a generally trapezoidal-shaped cross section and a second portion adjacent to the first portion and having a generally rectangular-shaped cross section;
a pair of spaced-apart rails extending between the stiles, each of the rails having ends comprising a base portion and a tabbed portion extending therefrom; wherein each tabbed portion comprises a generally trapezoidal-shaped cross section that is received within the first portion of a groove of one of the stiles;
a pair of opposing elongate inserts, each insert comprising a plurality of spaced-apart holes and disposed within the second portion of the groove of one of the stiles and extending in a direction generally parallel to the longitudinally extending groove; and
a plurality of louvers having pins, the pins being received within the holes of the elongate inserts and adapted for rotation within the holes.

11. The shutter assembly of 10 wherein the base portions of each of the spaced-apart rails are received within the second portions of the grooves of the stiles.

12. The shutter assembly of 10 wherein each stile further comprises an inside face, and wherein the generally rectangular-shaped cross section of the groove is proximal the inside face.

13. The shutter assembly of 10 wherein each of the spaced-apart rails further comprises a recess extending between the first and second ends, the recess configured to receive an elongate edge of one of the plurality of louvers.

14. A method for fabricating a shutter assembly, the method comprising:
forming a pair of grooved stiles, each stile having a longitudinally extending, multi-sectioned groove, the multi-sectioned groove comprising a first portion and a second portion adjacent to the first portion; wherein the cross-sectional shape of the second portion differs from the cross-sectional shape of the first portion;
forming a pair of rails, each of the rails having a pair of ends, each end comprising a cross-sectional shape complementary of first and second portions of the multi-sectioned groove;
disposing the ends of the first rail into the multi-sectioned grooves of the stiles to form a first and a second joint; and
disposing the ends of the second rail into the multi-sectioned grooves of the stiles to form a third and a fourth joint, thereby assembling a first shutter panel.

15. The method of claim 14 further comprising
disposing a first elongate insert that includes at least one hole within one of the portions of the first multi-sectioned groove, thereby forming a fifth joint; and
coupling at least one louver to the first elongate insert.

16. The method of claim 14 further comprising:
disposing a second elongate insert that includes at least one hole within one of the portions of the second multi-sectioned groove of the second stile, forming a sixth joint; and
coupling at least one louver to the first and second elongate inserts.

17. The method of claim 16 further comprising:
coupling pins to two opposite ends of the at least one louver; wherein the two pins extend from the louver ends; and
inserting a first of the pins into a hole in the first elongate insert and inserting the second of the pins into a hole in the second elongate insert.

18. The method of claim 16 further comprising:
Applying one of the following to at least one of the joints: an adhesive and a fastener.

19. The method of claim 16 further comprising:
forming a frame; and
coupling the first shutter panel to the frame.

20. The method of claim 17 wherein, before the ends of the first rail are disposed within the stiles, the first elongate insert is disposed within the first stile and the second elongate insert is disposed within the second stile.

21. The method of claim 20 wherein the first and second pins are inserted into holes in the first and second elongate inserts before the ends of the first rail are disposed into the stiles.

22. The method of claim 17 wherein the ends of the first rail are disposed into the stiles before the first elongate insert is disposed within the first stile.

23. The method of claim 14 wherein forming the multi-sectioned groove includes forming the first portion having a generally rectangular-shaped cross section, and forming the second portion having a generally trapezoidal-shaped cross section.

24. The method of claim 23 wherein forming the ends of the rails includes forming a generally rectangular-shaped base portion and a generally trapezoidal-shaped tabbed portion;
disposing the base portion into the first portion of the multi-sectioned groove; and
disposing the tabbed portion into the second portion of the multi-sectioned groove.

25. The method of claim 24 wherein disposing the ends of the first rail into the multi-sectioned grooves comprises sliding the base portions of the first rail into the longitudinally extending, multi-sectioned groove of the stiles.
